(19) United States
(12) Patent Application Publication
(10) Pub. No.: US 2007/0040117 A1
(43) Pub. Date: Feb. 22, 2007

(54) Standard specimen for probe shape evaluation and method for evaluating probe shape

(75) Inventors: Hiroshi Ito, Ibaraki (JP); Shingo Ichimura, Ibaraki (JP); Toshiyuki Fujimoto, Ibaraki (JP); Hidehiko Nonaka, Ibaraki (JP)

Correspondence Address: MORGAN LEWIS & BOCKIUS LLP, 1111 PENNSYLVANIA AVENUE NW, WASHINGTON, DC, 20004, US

(73) Assignee: National Institute of Advanced Industrial Science and Technology

(21) Appl. No.: 11/504,015

(22) Filed: Aug. 15, 2006

(30) Foreign Application Priority Data
Aug. 16, 2005 (JP) P. 2005-236156

(51) Int. Cl. G21K 7/00

(52) U.S. Cl. 250/309

(57) ABSTRACT

The present invention relates to a standard specimen for evaluating a shape of a probe of a probe microscope, which includes a multi-layer film subjected to a selective etching and a line width and a line space defined by a thickness of the layer and a line height defined by an etching amount; and a method for evaluating a probe shape of a probe microscope using the standard specimen.

### FIELD OF THE INVENTION

The present invention relates to a method of evaluating a shape of a probe portion of a scanning probe microscope (SPM) such as a scanning tunneling microscope (STM) and a scanning atomic force microscope (AFM), and a standard specimen for evaluating the same.

### BACKGROUND OF THE INVENTION

As shown in FIG. 1, a scanning probe microscope traces a surface to form an image with controlling the distance between a probe (probe or tip) and a sample constant. At that time, a distance between the probe and a nearest portion of the specimen is controlled so as to be constant. Therefore, when the probe is large, trajectories (chain line; acquired image data) of the nearest portion of the specimen and a tip end of the probe are not necessarily coincided in some cases. Accordingly, the size and shape of the probe largely affect on the resolving power and shape measurement error.

Further, a probe may vary in its shape or wear to cause deterioration in the resolving power during use. In order to measure the shape of the probe at that time, the probe is once removed from an apparatus and subsequently observed with an electron microscope; or a specimen having a special shape (knife edge or protrusion), which is exclusively prepared and called a tip characterizer, is observed with an atomic force microscope. The former one takes much labor to measure the state of the probe for every measurement, and the latter has a difficulty to supply the tip characterizer guaranteeing a measurement accuracy of 10 nm or less (patent documents 1 and 2).

Patent document 1: JP-A-2001-208669

Patent document 2: JP-A-2004-264039

### SUMMARY OF THE INVENTION

Although the scanning probe microscope has a high resolving power (several nanometers or less), it is difficult to guarantee the resolving power and error thereof. Furthermore, owing to the size and asymmetricity of a probe, an artifact (distortion of a measurement shape and asymmetricity) is present. When the shape of a used probe (sharp probe) can be measured, the resolving power and measurement error can be specified, and a true shape after considering the probe shape can be extracted through an image processing. In order to achieve the object, a probe shape is measured with employing a structure for evaluating a probe shape.

Conventionally, as a tip characterizer which is prepared according to a so-called semiconductor micro processing technology, only a tip characterizer having a size of several tens nanometers can be prepared. Although it can be processed by the use of a focusing ion beam for miniaturization, the shape and size thereof cannot be guaranteed. When a tip characterizer specimen having a shape of 10 nm or less and a guaranteed size can be supplied, a probe shape can be readily measured with an accuracy of nanometer order by the use of an atomic force microscope before and after the measurement. Simultaneously, the reliability (accuracy, error and the like) of measured image data can be added.

Namely, the present invention relates to the followings.

(1) A standard specimen for evaluating a shape of a probe of a probe microscope, which comprises a multi-layer film subjected to a selective etching, said specimen having a line width and a line space defined by a thickness of said layer and a line height defined by an etching amount.

(2) The standard specimen according to (1), which has a knife-edge structure having a guaranteed minimum width.

(3) The standard specimen according to (2), said guaranteed minimum width of the knife-edge structure being 1 to 50 nm.

(4) The standard specimen according to (1), which has a comb-type structure.

(5) The standard specimen according to (3), wherein the comb-type structure is a structure having two or more different line widths and/or line spaces of 1 to 500 nm.

(6) The standard specimen according to (1), which has a knife-edge structure having a guaranteed minimum width and a comb-type structure in combination.

(7) The standard specimen according to (6), said guaranteed minimum width of the knife-edge structure being 1 to 50 nm.

(8) The standard specimen according to (6), wherein the comb-type structure is a structure having two or more different line widths and/or line spaces of 1 to 500 nm.

(9) A standard specimen for evaluating a shape of a probe of a probe microscope, which comprises two or more of the standard specimens according to (2) laminated to one another.

(10) A standard specimen for evaluating a shape of a probe of a probe microscope, which comprises two or more of the standard specimens according to (4) laminated to one another.

(11) A standard specimen for evaluating a shape of a probe of a probe microscope, which comprises two or more of the standard specimens according to (6) laminated to one another.

(12) A method for evaluating a shape of a probe of a probe microscope, which comprises measuring a standard specimen with the probe microscope,

wherein the standard specimen comprises a multi-layer film subjected to a selective etching, said specimen having a line width and a line space defined by a thickness of said layer and a line height defined by an etching amount.
   (13) The method according to (12), wherein the standard specimen has a knife-edge structure having a guaranteed minimum width.
   (14) The method according to (13), said guaranteed minimum width of the knife-edge structure being 1 to 50 nm.
   (15) The method according to (12), wherein the standard specimen has a comb-type structure.
   (16) The method according to (15), wherein the comb-type structure is a structure having two or more different line widths and/or line spaces of 1 to 500 nm.
   (17) The method according to (12), wherein the standard specimen has a knife-edge structure having a guaranteed minimum width and a comb-type structure in combination.
   (18) The method according to (17), said guaranteed minimum width of the knife-edge structure being 1 to 50 nm.
   (19) The method according to (17), wherein the comb-type structure is a structure having two or more different line widths and/or line spaces of 1 to 500 nm.
   (20) The method according to (13), wherein two or more of said specimens are laminated to one another.
   (21) The method according to (15), wherein two or more of said specimens are laminated to one another.
   (22) The method according to (17), wherein two or more of said specimens are laminated to one another.

According to the present invention, a microstructure which cannot be realized by a preparation according to a lithography method can be prepared, and the minimum size can be guaranteed. Further, when a focusing ion beam is used for the preparation, it is necessary to prepare each specimen separately. On the contrary, according to the method employing a multi-layer, it is possible to produce the same specimens in large quantities.

In comparison with a method where a probe shape is measured with an electron microscope, shapes of the probe before and after the measurement can be obtained according to the present invention, so long as there is only an atomic force microscope that is used for the observation. Furthermore, accuracy of nanometer level can be realized. Accordingly, from a practical viewpoint, a shape evaluation comparative to an electron microscope can be carried out in a short period of time.

### BRIEF DESCRIPTION OF THE DRAWINGS

FIG. 1 is a conceptive descriptive diagram of a scanning probe microscope.

FIG. 2 is an example of a sectional view of a standard specimen for measuring a shape of a probe.

FIG. 3 is a descriptive diagram for the preparation of a standard specimen.

FIG. 4 is an AFM image of a knife-edge having a size of 10 nm.

FIG. 5 is a diagram showing an evaluation method of an entire shape of a probe.

FIG. 6 is an AFM image of a probe evaluation structure.

FIG. 7 is a diagram showing an obtained shape of a tip end of a probe.

FIG. 8 is a diagram showing an obtained entire structure of a probe.

FIG. 9 is a diagram describing an advantage of a comb-type structure.

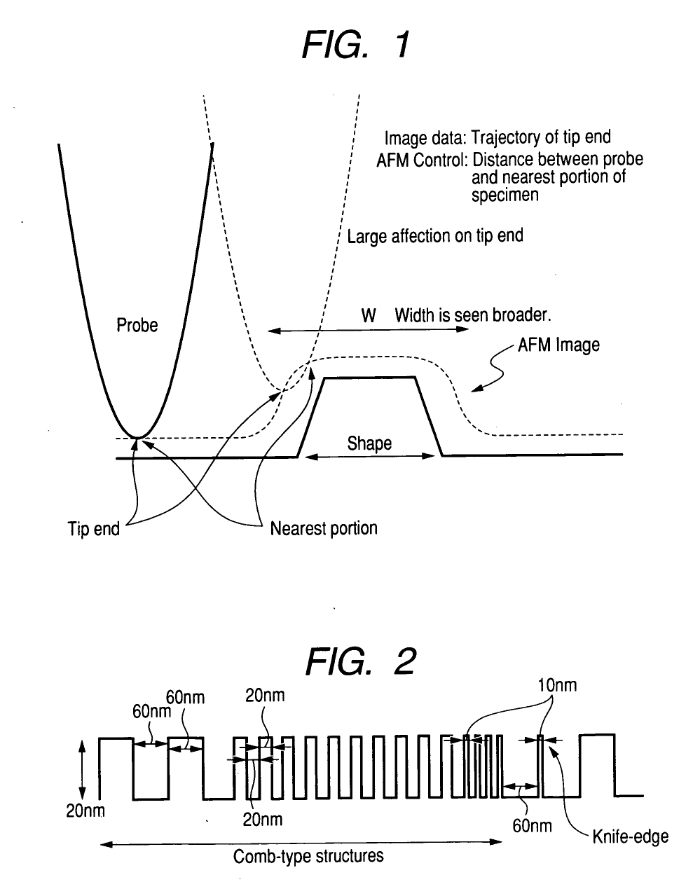

### DETAILED DESCRIPTION OF THE INVENTION

The followings describe the present invention in detail.

In order to evaluate a probe having a nanometer size, a resolving power measurement tool having a size equal to or less than the probe is necessary. Herein, a standard specimen where a size of the minimum structure for measuring a probe shape is 100 nm or less (typically 10 nm, as shown in FIG. 2) is measured with a probe microscope used for measurement, and the resolving power is extracted from image data thus obtained.

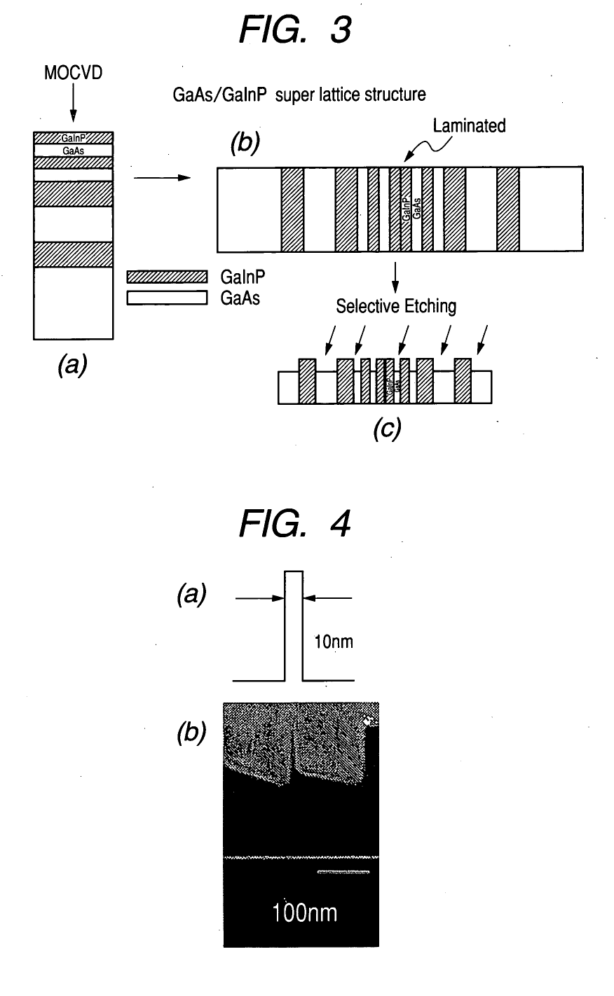

As shown in FIG. 3, in order to prepare a specimen for measuring a probe shape as mentioned above, a multi-layer film having two or more kinds of layer or a super lattice structure is prepared, followed by selectively etching the section thereof to form a convexo-concave structure. By leaving only one kind of material according to the selective etching, a protrusion or dent corresponding to a thickness of an etched part of the multi-layer film or the super lattice can be formed. According to the method, a comb-type structure or a knife-edge structure is prepared and therewith a specimen for evaluating a probe is prepared.

According to the present invention, the knife-edge structure is guaranteed to have a minimum width of 1 to 50 nm.

Further, “comb-type structure” herein means a structure having two or more different line widths and/or line spaces of from 1 to 500 nm.

A multi-layer film which is used to prepare a standard specimen for measuring a probe shape is prepared in such a manner that a super lattice structure is prepared by utilizing a multi-layer preparation technique capable of controlling a thickness at accuracy of several nanometers or less, followed by selectively etching a side surface. When the CVD method or MBE method is used to prepare the multi-layer film, a nano-sized standard structure controlled by monolayer unit can be prepared. In this regard, line widths and line spaces of the standard specimen according to the present invention are defined by the thickness of the multi-layer, and the line heights thereof are defined by the etching amount. The size of the standard specimen according to the present invention can be regulated at accuracy of less than 10 nm.

As a typical example, a super lattice structure of GaAs and InGaP is prepared by the MOCVD method and a thickness of the InGaP layer is controlled so as to correspond to a size of a protrusion. A section is polished, and subsequently the GaAs layer is etched with a solution of sulfuric acid and hydrogen peroxide, thereby preparing a predetermined structure (FIG. 3).

As a multi-layer film, a combination of silicon and a silicon oxide film can be also employed.

Two or more standard specimens of the present invention can be used by laminating them to one another. In this regard, same or other kinds of specimens may be used in combination.

Hereinafter, the present invention will be described in more detail with reference to Example.

### EXAMPLE 1

A tip characterizer shown in FIG. 2, which has a periodic structure of 60, 20 and 10 nm line widths and a protrusion of 10 nm (knife-edge), was designed and prepared. Using a GaAs wafer, a super lattice structure was prepared. A super lattice structure of GaAs/InGaP was prepared by means of the MOCVD method or MBE method and selectively etched with a solution of sulfuric acid and hydrogen peroxide, and thereby a designed structure was prepared at the accuracy of 2 nm or less. The width and length of a probe can be measured using a prepared periodic structure.

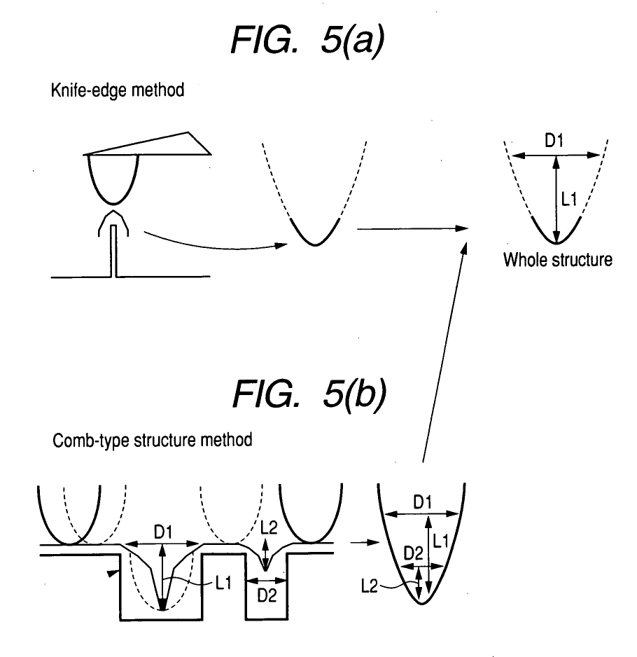

As shown in FIG. 4, a knife-edge having a size of 10 nm (curvature radius: 5 nm) suitable for measuring a shape of a tip end of the probe at the resolving power of nanometer was prepared. According to the nanostructure thus prepared, a knife-edge structure is used to measure a tip end portion as shown in FIG. 5A, and a diameter and a length of a peripheral portion of the probe are measured from a profile of an AFM image of a comb-type structure as shown in FIG. 5B. By combining these measurements, the entire shape of the probe can be evaluated.

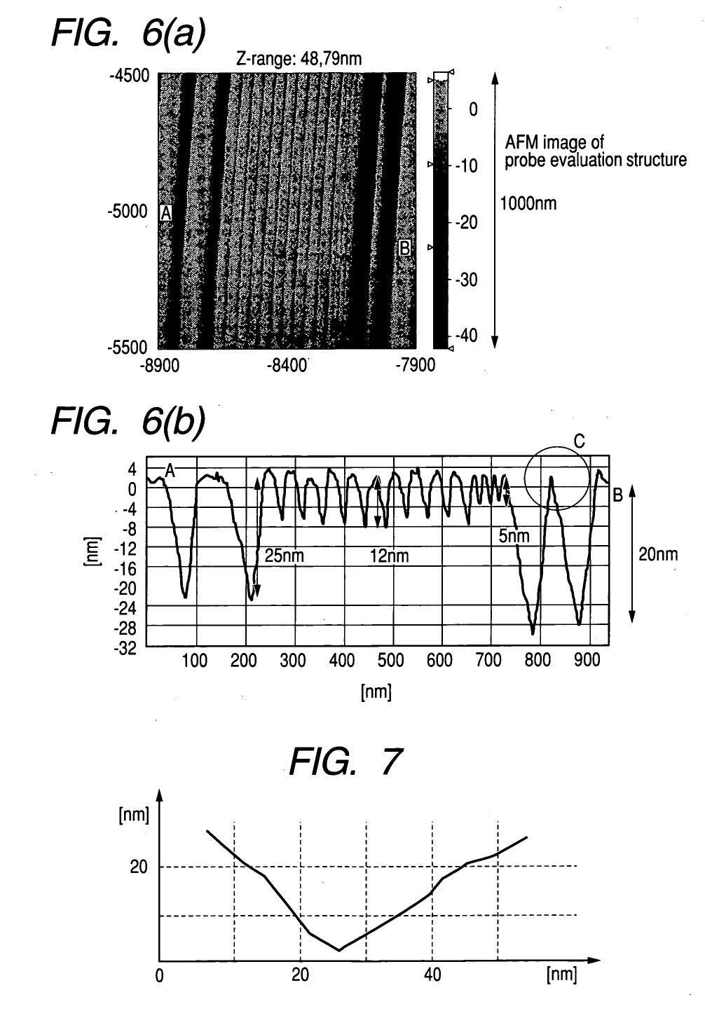

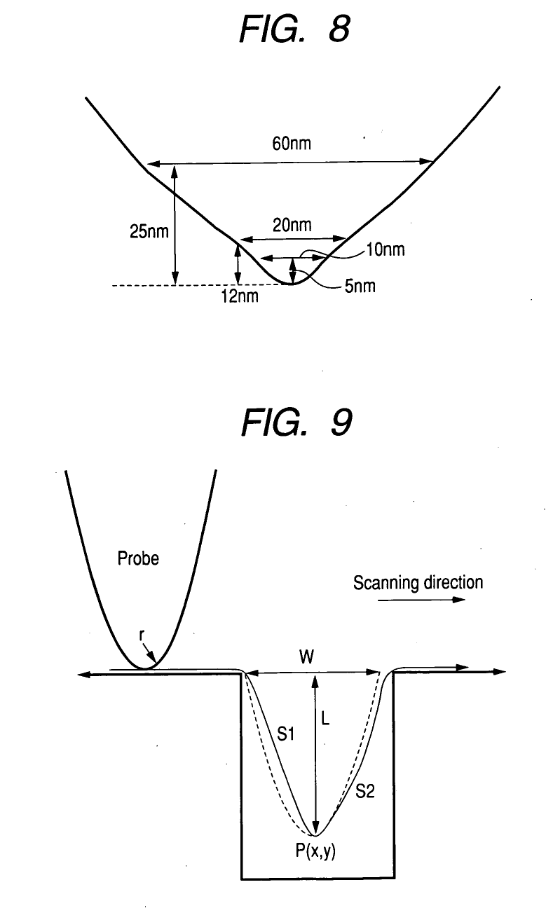

FIG. 6A shows an AFM image of a probe evaluation specimen having a structure shown in FIG. 2, being observed with an atomic force microscope. The line profile thereof is shown in FIG. 6B. From an encircled portion C of the graph, the shape of the tip end of the probe shown in FIG. 7 was obtained by using the method of FIG. 5A. Since depths of the probe intruded in 60, 20 and 10 nm comb-type structures were read as 25, 12 and 5 nm, respectively, the shape of the probe was also evaluated according to this method. As a result, a shape shown in FIG. 8 was obtained.

In an usual atomic force microscope, owing to a response speed of probe control, rise and decay slopes generate a time delay as shown in FIG. 9. Even in this case, according to the method using a comb-type structure, a width (W), a length (L) and a position of a peak (P) can be measured without any affection caused by the response characteristics of an apparatus.

A GaAs layer or an InGaP layer is doped to impart the electric conductivity and thereby enabled to use in a tunneling microscope and a probe microscope employing an amount of electricity to control a probe. According to the probe evaluation method in which a comb-type structure and a knife-edge method is employed in combination, the knife-edge structure evaluates a tip end of the probe, the comb-type structure evaluates an outer shape of the probe, and then the entire shape of the probe can be determined. In this case, a period of the comb-type structure can be prepared to several hundreds nanometers.

In the preparative example, two same substrates were laminated. However, when two or more kinds of substrates with different kinds of structures are laminated, a probe evaluation structure with a more complicated combination or that prepared by combining structures different in the width can be prepared.

According to the above tip characterizer, several kinds of periodic structures are investigated whether the respective lines can be resolved or not with an atomic force microscope, and thereby a probe having necessary resolving power can be readily selected. By observing which line width is resolved, visual judgment can be performed. For example, judgment can be performed by observing which line width of 60, 20 and 10 nm of FIG. 6A is resolved.

When a comb-type structure is used, a width and a length of a probe, which hardly depend on the tracking error owing to the response of the unit, can be obtained. Slopes such as S1 and S2 in FIG. 9 are affected by the response of the unit. However, since the width (W), the length (L) and the peak position P (x, y) are less affected, an outer shape of a probe which is less affected by the response of the unit can be measured.

With a probe microscope that is used in the measurement and a probe thereof, the resolving power can be measured. Furthermore, the probe wears in accordance with the number of times of measurement, and the extent of wear (resolving power) can be investigated.

By using a measured shape of a probe, a profile can be corrected, the error in the shape measurement can be specified and a shape correction can be applied.

When a multi-layer film of GaAs/InGaP or silicon and a silicon oxide is used, a variation with time of a specimen can be suppressed by employing a material difficult to be oxidized (InGaP or silicon oxide film) for the surface side. According to the necessity, a hydrophilic or hydrophobic material can be disposed on a surface side as well.

According to the above tip characterizer, by observing several kinds of periodic structures with an atomic force microscope to measure a width (W in FIG. 10) of the comb-type structure and a depth (L in FIG. 10) intruded by a probe, a probe having an aspect ratio necessary for measurement can be identified.

While the present invention has been described in detail and with reference to specific embodiments thereof, it will be apparent to one skilled in the art that various changes and modifications can be made therein without departing from the scope thereof.

This application is based on Japanese patent application No. 2005-236156 filed Aug. 16, 2005, the entire contents thereof being hereby incorporated by reference.

What is claimed is:

1. A standard specimen for evaluating a shape of a probe of a probe microscope, which comprises a multi-layer film subjected to a selective etching, said specimen having a line width and a line space defined by a thickness of said layer and a line height defined by an etching amount.

2. The standard specimen according to claim 1, which has a knife-edge structure having a guaranteed minimum width.

3. The standard specimen according to claim 2, said guaranteed minimum width of the knife-edge structure being 1 to 50 nm.

4. The standard specimen according to claim 1, which has a comb-type structure.

5. The standard specimen according to claim 3, wherein the comb-type structure is a structure having two or more different line widths and/or line spaces of 1 to 500 nm.

6. The standard specimen according to claim 1, which has a knife-edge structure having a guaranteed minimum width and a comb-type structure in combination.

7. The standard specimen according to claim 6, said guaranteed minimum width of the knife-edge structure being 1 to 50 nm.

8. The standard specimen according to claim 6, wherein the comb-type structure is a structure having two or more different line widths and/or line spaces of 1 to 500 nm.

9. A standard specimen for evaluating a shape of a probe of a probe microscope, which comprises two or more of the standard specimens according to claim 2 laminated to one another.

10. A standard specimen for evaluating a shape of a probe of a probe microscope, which comprises two or more of the standard specimens according to claim 4 laminated to one another.

11. A standard specimen for evaluating a shape of a probe of a probe microscope, which comprises two or more of the standard specimens according to claim 6 laminated to one another.

12. A method for evaluating a shape of a probe of a probe microscope, which comprises measuring a standard specimen with the probe microscope,
wherein the standard specimen comprises a multi-layer film subjected to a selective etching, said specimen having a line width and a line space defined by a thickness of said layer and a line height defined by an etching amount.

13. The method according to claim 12, wherein the standard specimen has a knife-edge structure having a guaranteed minimum width.

14. The method according to claim 13, said guaranteed minimum width of the knife-edge structure being 1 to 50 nm.

15. The method according to claim 12, wherein the standard specimen has a comb-type structure.

16. The method according to claim 15, wherein the comb-type structure is a structure having two or more different line widths and/or line spaces of 1 to 500 nm.

17. The method according to claim 12, wherein the standard specimen has a knife-edge structure having a guaranteed minimum width and a comb-type structure in combination.

18. The method according to claim 17, said guaranteed minimum width of the knife-edge structure being 1 to 50 nm.

19. The method according to claim 17, wherein the comb-type structure is a structure having two or more different line widths and/or line spaces of 1 to 500 nm.

20. The method according to claim 13, wherein two or more of said specimens are laminated to one another.

21. The method according to claim 15, wherein two or more of said specimens are laminated to one another.

22. The method according to claim 17, wherein two or more of said specimens are laminated to one another.
